(19) United States
(12) Patent Application Publication
(10) Pub. No.: US 2009/0063296 A1
(43) Pub. Date: Mar. 5, 2009

(54) Business method for improving the flower industry

(76) Inventor: Eftim Cesmedziev, San Pedro, CA (US)

Correspondence Address: EFTIM CESMEDZIEV, 326 S. Miraleste Drive 198, San Pedro, CA, 90732, US

(21) Appl. No.: 11/899,035

(22) Filed: Sep. 4, 2007

(51) Int. Cl. G06Q 30/00

(52) U.S. Cl. 705/26

(57) ABSTRACT

A business method in flower industry is created, where internet technology is that brings more revenue to the flower industry, using different opportunity that internet technology offers to customers and businesses. Flower industry customers have own web page where may receive a business offers.

### RELATED APPLICATION

Not applicable.

### CROSS-REFERENCE TO RELATED APPLICATION

Not applicable.

### STATEMENT REGARDING FEDERALLY SPONSORED RESEARCH OR DEVELOPMENT

Not applicable.

### TECHNICAL FIELD

The present invention broadly relates to a business method for improving the flower industry, and more particularly, to a business method that improves the flower industry business using technical devices and adequate software, opening the flower's industry network to other businesses and to the customers around the world.

### BACKGROUND OF THE INVENTION

Flower industry develops drastically in last few decades. From a local flower store that covers a certain area, flower industry develops to a chain of flower stores that cover the world with its services and products, using internet technology. Today, flower industry customer may visit a flower store web site, may search for products and services posted on the web site, order desired items, pay for them, and flower store will deliver ordered products at desired address, using flower stores network. That flower stores network is managed by a flower stores managing company that have a business agreement with multitude of flower stores around the world. Main business of that company is to take care of businesses and communications between flower stores, so flower store customer can be satisfied with flower industry products and services.

However, in the prior art of delivering flowers and goods, the customers are not involved in the flower industry network. This novelty of the invention allowed the customer more active role in the flower industry, where will be developed close business relations between customers and representative of the flower industry. Novelty is that flower stores as a part of flower stores managing company may allow to the customers and businesses to use its secure web site service providing system network, setting them a secure personal web page under their secure web site managing company domain address, where customers may use all advantages of the flower industry network. Every flower industry customer has its own secured name and/or ID and/or password and other protective devices on its own web page. A flower industry customer may reach its web page using a desk computer with internet access, lap top computer with internet access, hand held devices with internet access, and/or mobile (cell) phone with internet access. Every flower industry customer may do any legal business trough its web page, including search, choose, order and pay products and services from variety of different businesses, to send and receive e-mails, to send and receive text, image(s), audio record(s) or audio-video record(s) to the other flower industry customers along with a flowers. This is different than he prior art in flower industry, because a prior art do not involve a flower industry customer in its world wide web site service providing system network.

Another limitation of the prior art is that today's flower business is oriented only to the flower business. This invention allow other businesses to use flower industry world wide web site service providing system network, offering products and services to flower industry customers, creating business relations with local flower stores and flower industry managing company that manages the flower industry network world wide. This will bring more revenue to the flower industry. This is different than he prior art in flower industry, because prior art is oriented only to the flower industry and in not open to other businesses locally or world wide.

Another limitation of the prior art is that the gifts are not complete because receiver cannot see and hear the sender's messages. The receiver receives only the physical part of the gift. We may see that, if we go to web sites www.teleflora.com, www.ftd.com or other flower stores web sites, or visit a flower store at its location. Today's technology allowed the sender to create, send and receive text, image(s), audio file(s) and/or audio-video file(s) and send to the receiver flower industry customer's web page along with a flower order. Using this novelty of the invention, flower industry customer that receives flower may receive also text, image(s), audio file(s) and/or audio-video file(s) on receiver's web page, where flower industry customer may see them using its mobile (cell) phone with internet access, a computer with internet access, and/or hand held devices with internet access when he/she opens its web page. Receiver may see the message in a same time when receiver receives a flower on its hand held devices with internet access or on its mobile (cell) phone with an internet access, or desk computer with internet access, lap top computer with internet access. This improvement of delivering the gifts is part of novelty that this invention is addressing it.

Using the novelties of this invention will bring a more revenue for the flower industry and better customer services for flower industry customers.

### BRIEF SUMMARY OF THE INVENTION

The general purpose of the present invention, which will be described subsequently in greater detail later, is to provide a method for improving the business in flower industry, to provide better products and services to the flower industry customers, to involve the flower industry customers in its network and help customers with better services, heretofore as a prior art and novel features that which is not anticipated, rendered obvious, suggested, or even implied by any of the prior art, either alone or in any combination thereof.

Moreover, one embodiment of the present invention includes opportunity for the flower industry to offer its world wide flower store network to other businesses using its world wide network. A local flower store and/or flower industry managing company may have business agreement(s) with other businesses and give opportunity to those businesses to offer its products and services to the flower industry customers, locally and/or internationally for a fee or for free.

Another embodiment of the invention includes offer from the flower industry managing company or from a flower store to allow a customer to use their web site service providing system, to set up to the customer special secured web page and e-mail address under the flower store or flower industry network web site domain. Flower industry customers may get their web pages and e-mail address for free, where all customers may communicate between themselves freely without any limitation sharing text, images, an audio files and/or audio-video files. On every customer's web page any businesses and people that has a business agreement with a flower industry representative, may advertise them self, their products and services for a fee paid to the flower store or flower industry managing company and offer products and services to the flower industry customers. The flower industry customers can do any business without any limitation with those companies that offers products to the flower industry customer's web page. Flower industry customer's web page is set up with secure devices and has a secure link to one or more financial institutions and with a secure link with its own checking and saving accounts. Flower industry customers may reach its web page using a desk computer with internet access, lap top computer with internet access, hand held devices with internet access, and/or mobile phone with internet access.

Another embodiment of the invention includes a flower industry customer that may create text, image(s), audio file(s) and/or audio-video file(s) and send to the receiver flower industry customer's web page along with a flower order. When a flower is delivered to the receiver, flower industry customer receives information such as text, image(s), audio file(s) and/or audio-video file(s) to receiver's web page. Receiver may see the information on its hand held devices with internet access, on its mobile (cell) phone with an internet access, desk top computer with internet access, and/or lap top computer with internet access, in a same time when receiver receives flower.

In this respect, before explaining at least one embodiment of the invention in detail, it is to understand that invention is not limited in its application to the details and steps of construction and to arrangements of the components/steps set forth in the following description or illustrated in the drawings. The invention is capable of other embodiments and of being practiced and carried out in various ways. Also, it is to be understood that the phraseology and terminology employed herein is for the purpose of description and should not be regarded as limiting.

As such, those skilled in the art will appreciate that the conceptions, upon which this disclosure is based, may readily be utilized as a basis for the designing of other structures, devices, methods and system for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application not is it intended to be limiting as to the scope of the invention in any way.

### BRIEF DESCRIPTION OF THE DRAWING

Illustrative embodiments of the invention are described below with reference to the following drawing, in which like numerals reference like elements, and wherein:

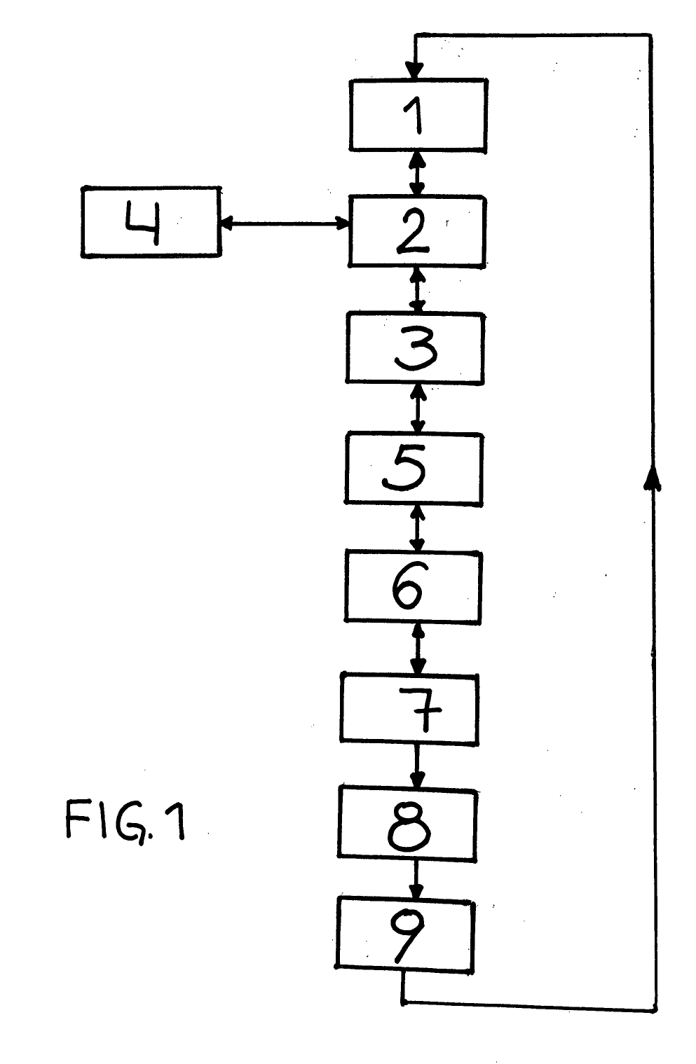

On FIG. 1-3 are shown block diagrams of the business method in accordance with an embodiment of the invention. By way of illustration, and without limitation, a single arrow indicate a many one ways communication and business between members, and a double arrow indicates a many two ways of communication and business relationship between members of the invention. Each box is a table in the database. Each box or circle has attributes (data fields) and relationships.

On FIG. 1 is shown block diagram of one embodiment of the invention. FIG. 1 shows basic steps and number of members of this embodiment of the invention, where:

a) box with numerical reference 1 indicates a flower industry customer;

b) box with numerical reference 2 indicates a flower store that is a part of flower stores managing company;

c) box with numerical reference 3 indicates a flower stores managing company web site service providing system, where flower store 2 web site service providing system is part of it;

d) box with numerical reference 4 indicates businesses that have business agreement with flower stores managing company web site service providing system;

e) box with numerical reference 5 indicates customer's secured web page;

f) box with numerical reference 6 indicates all activities that customer may do at its web page without any limitation;

g) box with numerical reference 7 indicates a financial process that taken upon customer's order of products and services;

h) box with numerical reference 8 indicates delivery of the products and services to the flower industry customer;

i) box with numerical reference 9 indicate proof of the delivery of the products.

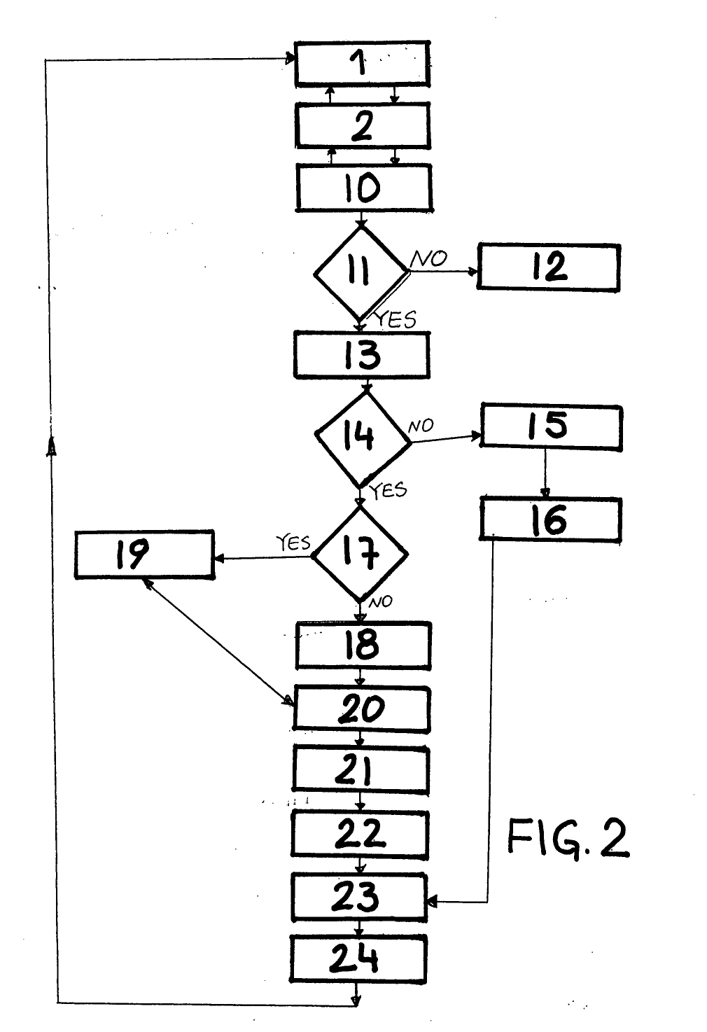

On FIG. 2 is shown block diagram of another embodiment of the invention. FIG. 2 shows basic members of this embodiment of the invention, where:

a) box with numerical reference 1 indicates a flower industry customer;

b) box with numerical reference 2 indicates flower store or flower store 2 web site service providing system;

c) box with numerical reference 10 indicate ordering flower;

d) box with numerical reference 11 indicates delivery process by flower store;

e) box with numerical reference 12 indicates customer's personal care for delivery;

f) box with numerical reference 13 indicates all necessary information given by a customer for successful delivery, such as receiver's address, phone number, and the like;

g) box with numerical reference 14 indicates creating additional messages to be delivered with the flower, such as text, image, audio and/or audio-video file;

h) box with numerical reference 15 indicates all necessary information needed for successful delivery are send to delivery flower store without additional messages;

i) box with numerical reference 16 indicates delivery flower store that prepare the flower for the delivery according the order from customer;

j) box with numerical reference 17 indicates decision made by customer, if customer needs a help for creating the messages;

k) box with numerical reference 18 indicates customer create the messages by its self,

l) box with numerical reference 19 indicates businesses or people that creates the messages for the customer for fee or for free;

m) box with numerical reference 20 indicates created message are posted on sending messages customer's web page;

n) box with numerical reference 21 indicates created message delivered to the receiver's web page from sending messages customer's web page;

o) box with numerical reference 22 indicates informing the receiver that receive created message on its web page;

p) box with numerical reference 23 indicates receiver that receive a flower and created messages;

q) box with numerical reference 24 indicates proof of delivery flower and messages send to the customer.

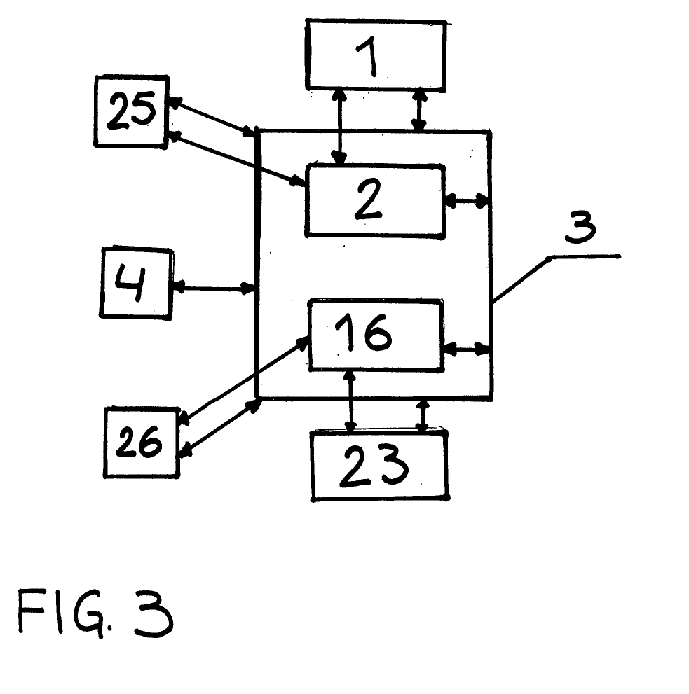

On FIG. 3 with numerical reference 3 is shown a flower stores managing company with two flower stores 2 and 16. However, in real situation flower stores managing company 3 manages multiple of flower stores and flower businesses, not just two flower stores. It should be understand that on FIG. 3 are shown basic steps and members of the business that managing company 3 has it, following the products from a flower store 2 to the flower store 16. Flower stores 2 and 16 and flower stores managing company 3 are used for the purpose of illustration and not is it intended to be limiting as to the scope of the invention in any way.

On FIG. 3 is shown block diagram of another embodiment of the invention. FIG. 3 shows basic members of this embodiment of the invention, where:

a) box with numerical reference 1 represents flower industry customer;

b) box with numerical reference 2 represents local flower store with its independent web site service providing system, as a part of flower stores managing company, and that local flower store is located close to the sending flower customer physical address of living;

c) box with numerical reference 16 represents local flower store with its independent web site service providing system, as a part of flower stores managing company, and that local flower store is located close to the receiving flower customer physical address of living;

d) box with numerical reference 23 represents receiving flower industry customer;

e) box with numerical reference 3 represents flower stores managing company that represents multitude of flower industry stores and flower stores managing company web site service providing system;

f) box with numerical reference 25 represents designated businesses that have a local business agreement with box with numerical reference as a part of world wide flower industry network business agreement with box with numerical reference;

g) box with numerical reference 26 represents designated businesses that have a local business agreement with box with numerical reference as a part of world wide flower industry network business agreement with box with numerical reference;

h) box with numerical reference 4 represents designated businesses that have a world wide flower industry network business agreement with box with numerical reference.

### DETAILED DESCRIPTION OF THE PREFERRED EMBODIMENTS

Aspects of the invention may be practiced using any suitable arrangement of the elements of the invention. Several different embodiments are described for purposes of illustration herein. On FIG. 1 is show block diagram of an embodiment in accordance with aspects of the invention. However, it should be understood that these illustrative embodiments of the invention should not be used to narrowly interpret the scope of the invention.

Customer 1 is visiting flower store 2 with intention to order products and services offered by the flower store 2. Flower store 2 has its own independent web site service providing system that is adequately and functionally connected with flower stores managing company web site service providing system 3. Flower store 2 with its own independent service providing system has business agreement with flower stores managing company service providing system 3 and is a part of the flower stores world wide network. Flower store 2 with its own independent service providing system may pay fee to the flower stores managing company service providing system 3 for its membership to the network, or to be member of the network for free. Flower stores managing company service providing system 3 offer to all flower stores web site service providing system that are members of the world wide network following, but not limited to:

a) an internet and functional web sites with database saved on a computer memory;

b) a single database or multiple databases, information relative to suppliers, products, services, customers and the like;

c) all needed hardware and software adequately and functionally connected to the financial institution and is all available to its customers without limitation, used for payments made in a variety of different ways, already known in prior art.

In one embodiment of the invention, both web sites service providing systems 2 and 3 offer variety of products and services to the flower industry customer 1, including by not limited to:

a) personal and secure web page 5 that is managed by flower stores managing company service providing system 3, located under flower stores managing company web site domain;

b) personal and secure web page 5 that is adequately and functionally linked with flower stores managing company web site service providing system 3, which protect privacy of the flower industry customer 1;

c) personal and secure web page 5 that is adequately and functionally linked to one or more customer's savings and/or checking accounts, that has adequate and functional links to shipping and handling institution with their system of delivery products and services that give to the customer 1 confirmation number and tracking number for ordered and shipped, handled and delivered products or services by customer 1, and the like;

d) personal and secure web page 5 that is adequately and functionally linked with one or more financial institutions for purposes of payment made in a variety of different ways, already known in prior art, including but not limited to credit/debit cards, pay by check, cash, and the like;

e) secure web page 5 with secure personal e-mail address and web page address;

f) personal and secure name, ID and personal secure password stored in the flower stores managing company web site service providing system 3, and other secure devices;

g) opportunity to reach its web page 5 using desk computer with internet access, lap top computer with internet access, hand held devices with internet access with internet access, and/or mobile (cell) phone with internet access;

h) full access and control over its web page 5, full access and control to any known up to date computer technology and devices, such as hand held devices with internet access, mobile (cell) phone with internet access, and the like;

i) opportunity to receives offers from other businesses and people 4 on its own personal web page 5, to have ability to order those products and services, to pay for them and to receive the ordered products from the customers web page, to share an images, audio files and/or audio-video files;

j) actively to communicate with other customer's secured personal web page in both ways for any reason;

k) business agreement which specifies the terms between flower industry customer 1 and flower stores managing company web sites service providing system 3;

l) business offer only from businesses and people 4 to the customer's web page 5 that already have business agreement with flower store 2 and flower stores managing company web site service providing system 3;

m) secured personal web page 5 with logos and/or signs for its favorite shops where customer want to shop, customers personal information, shopping requirement forms, links to businesses that offer products or services to the customer, payment option, shipping, handling and delivery option, shopping card, product and service catalog, may send and receive images, audio files, audio-video files trough its web page and the like already known in the prior art;

n) secured personal web page controlled by the customer and the customer may modify its secured personal web page without limitation;

o) secured personal web page, which is successfully linked to flower stores managing company web sites service providing systems that can transmit request for the desired products or service request from one of its web servers to a supplier of the desired product or service;

p) all transmits and transactions are recorded by the customer's secured personal web page and/or the web sites service providing systems to a computer memory and the customer may have an access into them.

In order to use its web page, flower industry customer need to have and to do following:

a) an internet access linked to the flower stores managing company web site service providing system that is adequately and functionally linked to customer's secured personal web page;

b) using unique customer name and/or ID and/or unique cod, password, customer may log in to its web page;

c) after placing the customer name and/or ID and/or unique cod, password on the flower stores web site service providing system, customer gives ordered data to be send;

d) flower stores managing company web sites services providing systems 3 has a system for checking that data;

e) if customer name and/or ID and/or unique cod, password(s) are correct, then the customer is lead to its secured personal web page, or if are not correct, denies access to the customer's secured personal web page; flower stores managing company web sites service providing systems may have other security devices to protect the privacy of the customers;

f) flower industry customer may design its web page without limitation;

g) businesses that have a business agreement with flower stores managing company web sites service providing systems may offer its products and services to the customer's web page;

h) customer may send and receive text, image(s), audio file(s) and/or audio-video file(s) to other flower industry customer's web pages, may search, choose, order and pay for products and services offered on its web page, where the flower stores managing company web site service providing system transmits the request from the customer for the ordered product or service request from one of its web servers to a supplier of the desired product or service;

i) the flower industry customer is atomically charged for its order by a financial institution using flower industry personal accounts;

j) all transactions are recorded by a flower stores managing company web site service providing system, by flower customer personal secure web page and by financial institution devices;

k) all paid orders are delivered to the customer desired destinations, by company who does that as a part of the business agreements between businesses and flower stores managing company web site service providing system.

On FIG. 1 is shown basic steps of practical implementation of the embodiment of the invention. Flower industry customer 1 is visiting flower store 2 at the store location or using an internet access, customer 1 may reach flower store 2 web site service providing system, which include flower store 2 web site. Flower store 2 web site service providing system may pay for its membership to the flower store managing company web site service providing system 3, or to get membership for free. Flower store 2 web site service providing system and flower stores managing company web site service providing system 3 have a business agreement that covers all aspects of the business between them. Flower store 2 web site service providing system and flower stores managing company web site service providing system 3 are adequately and functionally linked together, as well linked together with a financial institution devices. Using its customer name and/or ID and/or unique cod, password, customer 1 may log in to its web page. After placing the customer name and/or ID and/or unique cod, password on the flower stores managing company web site service providing system 3, customer 1 gives ordered data to be sending. Flower stores managing company web sites services providing systems 3 has a system for checking that data. If customer 1 name and/or ID and/or unique cod, password(s) are correct, then the customer is lead to its secured personal web page, or if are not correct, denies access to the customer's secured personal web page 5. Customer 1 may use flower store web site service providing system 3 at the flower store 2 location, to log in to its web page 5 that is offered by a flower store 2. Also, a flower industry customer 1 may reach its web page 5 using its own web site service providing system, such as computer with an internet access, hand held devices with an internet access, and/or mobile (cell) phone with an internet access. Using the web site service system 3, flower industry customer 1 may use products and services offered by businesses 4 that have business agreements with a flower store 2, i.e. with a flower stores managing company web site service providing system 3 where flower store 2 is part of it. After fulfilling the agreement, businesses get all necessary devices needed to reach flower stores web site service providing system 3 and customer web page 5. On its own web page, flower industry customer 1 may search, choose, order and pay for products and services, may send and receive text, images, audio files, and audio-video files, to have a adequately and functionally connection with a financial institutions and customer's own accounts, to have a shipping and handling devices, and the like and other activities 6. After ordering products and services posted on customer's web page 5, a flower industry customer 1 may use its money to pay for them, trough the financial institutions 7 devices that charge customers accounts. All transactions are recorder on the customer's web page 5 and on the financial institution 7 devices. Then, part of the money financial institution 7 may keep it for its services, and rest of the money are send to the company from where customer 1 order products and services. After paying for services and products, ordered products and services are delivered 8 to the customer's address, according information provided by customer to the company. After delivering, companies get a proof of delivery 9. These steps may be repeated again by the customer 1.

On FIG. 2 is shown basic steps of practical implementation of another embodiment of the invention. Flower industry customer 1 have multiple two way communication and business with flower store 2 and its web site service providing system. After searching, choosing, ordering 10 and paying for flower from flower store 2, flower store 2 employee will ask 11 customer 1, if customer 1 wants flower to be delivered by flower store 2. If, customer 1 says NO, then customer 1 pay to the flower store 2 and customer 1 will take care of delivery the flower 12. If customer 1 says YES, then flower store 2 employee will get 13 all necessary information given by a customer for successful delivery. Flower store 2 employee may offer other services to the customer 1, asking 14 the customer, if customer 1 wants to create additional messages that will be delivered to the flower receiver 23. If customer 1 says NO, then customer 1 pay to the flower store 2, and flower store 2 send 15 all necessary information to the delivery flower store 16, including but not limited to, address of the flower receiver, its phone number, what kind of flower, and the like. Flower store 2 may keep part of the money for its services, and other part to sent to the delivery flower store 16, trough flower stores managing company service providing system 3, where flower stores managing company service providing system 3 may also, keep some money for its services, and rest of the money give to the flower store 16. Flower store 16 receives delivery information, and according them, prepares the flower for delivery. Also, trough a financial institution, money is send to the flower store 16 from flower store 2, where a financial institution may charge for its service a fee. To send delivery information to the delivery flower store 16, flower store 2 use flower stores managing company web site service providing system 3, where flower store 2 may pay for that. If customer 1 says YES to the question if customer 1 want to create an additional messages that may be delivered together with a flower, then flower store 2 employee may ask 17 if customer needs a help with creating text, images, audio files, and/or audio-video files. If customer says NO, then customer 1 will create 18 those messages by its self using its own devices. If customer 1 says YES, then flower store 2 employee may offer businesses or people 19 who do that and have a business agreements with the flower store 2. Those businesses and people 19 may charge the customer 1 a fee or will do for free. After creating the messages, either by customer him self 18, or by businesses and people 19, created messages are posted on a customer's web page 20. From customer's web page 20 messages are delivered 21 to the receiver's web page 22 through adequate flower stores web site service providing system. Receiver 23 receives information that messages is receive on receiver's web page 22. Also, receiver 23 will receive a flower from delivery flower store 16. After delivery, proof of delivery 24 is send to the customer 1. These basic steps may be repeated again.

In another embodiment of the invention, a network of multiple of flower stores around the world creates an opportunity for the flower industry to offer its flower network to other businesses. On FIG. 3 are shown basic steps and members of this embodiment. Flower industry customer 1 may use business agreements that flower store 2 may have with local businesses 25 and their offers. Also, customer 1 may use products and services from businesses 4 that have a business agreement with flower stores managing company service providing system 3 and businesses 4 products and services are available to flower stores 2 and 16. Flower industry customer 1 may search, choose, order and pay for those products and services from businesses 25 and 4 using flower store 2 web site service providing system or customer's own web page that is adequately and functionally connected with flower store 2 web site service providing system.

Another embodiment invention shown on FIG. 3, is explained when flower industry customer 1 want to send a flower and other gifts to a flower industry customer 23. Flower industry customer 1 may send to customer 23 product gifts that are on sale locally to customer 23 living address, using flower stores managed company web site service providing system 3. When customer 1 wants to send product to customer 23 that lives over seas, a customer 1 may use flower stores managing company web site service providing system 3, where flower stores 2 and 16 are members, and contact flower store 16 that is located closest to customer 23 physical address, using any known way of communication known in communication art, including flower store 16 web site service providing system. Flower stores managing company web site service providing system 3 offer devices on its web site that customer entering the address of living of the customer 23, the web site 3 atomically shows the closest flower store 16 to the customer 23 address. Customer 1 may search for products and services from companies 26 that are placed on flower store 16 web sites service providing system. Flower industry customer 1 can do that because flower store 2 web site service providing system is adequately and functionally connected trough flower industry service providing system 3 with flower store 16 service providing system. Business company 26 has already have business agreement with a flower store 16, where customer 1 may order and pay for their product and services to a flower store 16. A flower store 16 receives the payment from the customer 1 and delivers gift card to customer 23 with information where customer 23 may pick up the product from designated company 26. In this way, the customer 23 will receive a gift, not money, and will still keep local services and warranties for the product. After pick up the gift by he customer 23 from a designated company 26, employee of that company 26 show proof that customer 23 pick up the gift to the flower store 16 employee, and flowers store 16 pay to the designated company 26 according their agreement between two businesses. Information of delivering the gifts is send back to the customer 1.

Every designated business companies 25, 26 and 4 already have a business contract agreement with a flower stores 2 and 16 and with a flower stores managing company web site service providing system 3, where are explain all business relations between them, such as way of paying, profit and the like.

In all embodiments of the invention where businesses or business company are mentioned, such as numerical references 4, 19, 25 and 26, businesses sign a business agreement with flower store of flower stores managing company, where in great details are explained business communications and relation between businesses and flower store(s) and flower stores managing company. After concluding the business agreement, businesses get all necessary secured devices, ID's, passwords, and all needed information to reach and log in the flower store web site service providing system and flower stores managing company web site service providing system 3, including but not limited to, customer's web pages, flower store web site, flower store managing company web site, and the like. Also, all businesses has an adequate and secure link with financial institutions, where customer may use all up to date devices for doing business with companies that have business agreement with flower industry representative.

Describing some embodiments of the invention, it should be apparent that all embodiments closely correlate between them self, using similar elements and steps. It should be taken in consideration that all explained steps, elements, processes and activities of the members of the invention that are explained in one embodiment, are valid in another embodiment. All explained embodiments, steps and members of the invention are connected together with referral numbers.

Having described the principles of my invention, it should be apparent that these steps of the invention are basic steps and that more steps may be added within the business method. Also, it should be apparent that these steps of the invention shown in FIG. 1 are basic steps and that more steps may be added within the method. From the foregoing, it will be appreciated that, although specific embodiments of the invention have been described herein for the purposes of illustration, various modifications may be made without deviating from the spirit and scope of the invention. Accordingly, I claim all steps and modifications as many come within the scope and spirit of the following claims.

I claim:

1. A business method for improving the flower industry comprising:
a) said flower store that has a physical location and flower store has its said flower store web site service providing system;
b) said flower store web site service providing system is part of a said flower stores managing company web site service providing system;
c) said flower store web site service providing system and said flower stores managing company web site service providing system may offer business agreements to said businesses and people to offer its products and services to the said flower industry customers;
d) said flower stores managing company web site service providing system offer to said flower industry customer personal secure web page under flower stores managing company web site service providing system.

2. A business method as recited in claim 1, wherein said flower store further includes flower store that has its own independent service providing system that is adequately and functionally connected with flower stores managing company web site service providing system.

3. A business method as recited in claim 1, wherein said flower store web site service providing system includes flower store web site service providing system that is part of a flower stores managing company web site service providing system regulated with business agreements between them.

4. A business method as recited in claim 1, wherein said flower store web site service providing system includes flower store web site service providing system that is adequately and functionally connected with flower stores managing company web site service providing system, where together may offer to its customers following services:
a) an internet and functional web sites with database saved on a computer memory;
b) a single database or multiple databases, information relative to suppliers, products, services, customers and the like;
c) all needed hardware and software adequately and functionally connected to the financial institution and is all available to its customers without limitation, used for payments made in a variety of different ways, already known in prior art;
d) personal and secure web page that is managed by flower stores managing company service providing system, located under flower stores managing company web site domain;
e) personal and secure web page that is adequately and functionally linked with flower stores managing company web site service providing system, which protects privacy of the flower industry customer;
f) personal and secure web page that is adequately and functionally linked to one or more customer's savings and/or checking accounts, that has adequate and functional links to shipping and handling institution with their system of delivery products and services that give to the customer confirmation number and tracking number for ordered and shipped, handled and delivered products or services by customer, and the like;
g) secure web page that is adequately and functionally linked with one or more financial institutions for purposes of payment made in a variety of different ways, already known in prior art, including but not limited to credit/debit cards, pay by check, cash, and the like;
h) secure web page with web page address and secure personal e-mail box;
i) personal and secure name and/or ID and/or personal secure password stored in the flower stores managing company web site service providing system, and other secure devices;
j) opportunity to reach its web page using desk computer with internet access, lap top computer with internet access, hand held devices with internet access with internet access, and/or mobile (cell) phone with internet access;
k) full access and control over its web page, full access and control to any known up to date computer technology and devices, such as hand held devices with internet access, mobile (cell) phone with internet access, computer with internet access, and the like;
l) opportunity to receives offers from other businesses and people on its own personal web page, to have ability to order those products and services, to pay for them and to receive the ordered products from the customers web page, to upload, download, attach, and/or to share an images, audio files and/or audio-video files;
m) actively to communicate with other customer's secured personal web page in both ways for any reason;
n) business agreement which specifies the terms between flower industry customer from one side, and flower store web sites service providing system and flower stores managing company web sites service providing system from the other side;
o) business offer only from businesses and people to the customer's web page that already have business agreement with flower store and flower stores managing company web site service providing system;
p) secured personal web page with links for its favorite shops where customer want to shop, customers personal information, shopping requirement forms, links to businesses that offer products or services to the customer, payment option, shipping, handling and delivery option, shopping card, product and service catalog, may send and receive images, audio files, audio-video files trough its web page and the like already known in the prior art;
q) secured personal web page controlled by the customer where customer may modify its secured personal web page without limitation;
r) secured personal web page, which is successfully linked to flower industry representative web sites service providing systems that can transmit request for the desired product or service request from one of its web servers to a supplier of the desired product or service;
s) transmits and transactions are recorded by the customer's secured personal web page devices and/or flower stores managing company web sites service providing systems to a computer memory and the customer may have an access into them.

5. A business method as recited in claim 1, wherein said personal secured web page includes personal secured web page that is adequately and functionally connected with flower stores managing company web site service providing system, where together may offer to its customers following:
a) an internet access to the flower stores managing company web site service providing system that is adequately and functionally linked to customer's secured personal web page;
b) using unique customer's name and/or ID and/or unique cod, password, customer may log in to its web page located at flower stores managing company web site service providing system's web site;
c) after placing the customer's name and/or ID and/or unique cod, password on the web site, customer gives ordered data to be send;
d) flower stores managing company web sites services providing systems has a system for checking that data;
e) if customer ID and unique cod, password(s) are correct, then the customer is lead to its secured personal web page, or if are not correct, denies access to the customer's secured personal web page; flower stores managing company web sites service providing systems may have other security devices to protect the privacy of the customers;
f) flower industry customer may design its web page without limitation;
g) businesses that have a business agreement with flower stores managing company web sites service providing systems may offer its products and services to the customer's web page;
h) customer may send and receive text, image(s), audio file(s) and/or audio-video file(s) to other flower industry customer's web pages, may search, choose, order and pay for products and services offered on its web page;
i) the flower industry customer is atomically charged for its order by a financial institution using flower industry personal accounts;
j) all transactions are recorded by a flower stores managing company web site service providing system, by flower customer personal secure web page and by financial institution devices;
k) all paid orders are delivered to the customer desired destinations, by company who does that as a part of the business agreements between businesses and flower stores managing company web site service providing system;
l) flower store and/or flower stores managing company and/or financial institution may charge flower industry customer for their services.

6. A business method as recited in claim 1, wherein said businesses and people includes businesses and people where:
a) businesses and people have its own web site service providing system that is adequately and functionally connected with flower stores managing company web site service providing system and have all needed hardware and software adequately and functionally connected to the financial institution and is all available to its customers without limitation, used for payments made in a variety of different ways, already known in prior art;
b) businesses and people have a business agreements with a flower store, its web site service providing system and/or flower stores managing company web site service providing system where are included all aspects of the business relation between them;
c) businesses and people may pay fee to the local flower store and/or flower stores managing company web site service providing system for advertising on customers web pages.
d) after fulfilling the agreement with flower store and/or flower stores managing company web site service providing system, businesses and people receive a secure and personal name and/or ID and/or unique cod, password, and have a access to customers web page trough flower store and/or flower stores managing company web site service providing system;
e) using unique businesses and/or people name and/or ID and/or unique cod, password, businesses and people may log in to its web page located at flower stores managing company web site service providing system and offer products and services to flower store customers;
f) after placing the businesses and people name and/or ID and/or unique cod, password on the flower stores web site service providing system, customer gives ordered data to be send;
g) flower stores managing company web sites services providing systems has a system for checking that data;
h) if businesses and people name and/or ID and/or unique cod, password(s) are correct, then the businesses and people are lead to flower stores managing company web sites services providing systems, from where they may send messages customers web pages, or if are not correct, denies access to the businesses and people.

7. A business method as recited in claim 1, wherein said flower store web site service providing system includes flower store web site service providing system that is part of a flower stores managing company web site service providing system where customer using its own web page devices may create text, an image(s), an audio file(s) and/or audio-video file(s) that can be delivered together with flower to the flower receiver using a flower receiver personal secure web page that is part of flower stores managing company web site service providing system.

8. A business method as recited in claim 1, wherein said flower stores managing company web site service providing system includes flower stores managing company web site service providing system that have a multiple of flower stores web site service providing system, where:
a) every flower store web site service providing system that is member of flower stores managing company web site service providing system contains web site address where web site is located;
b) adequate and functionally connected hardware and software with web sites and customers web pages;
c) web site service providing system include, but not limited to battery or other electric source, cables, server with data, internet provider, web site host, web site design, and other adequately and functionally connected hardware and software that provide successful work to the web site service providing system.

9. A business method for improving the flower industry future comprising:
a) flower store customer may visit flower store at the location or to visit flower store web site service providing system;
b) flower store customer may search, choose, order and pay for flower from the store, either at the location or using flower store web site service providing system, using the flower store financial devices that are connected with financial institution web site service providing system and devices;
c) flower store offers to its customer's opportunity to deliver ordered flowers;
d) if flower customer do not want flower store employees to deliver the flowers, then flower customer pay for products and services to the flower store and take care of delivery by him/her self;
e) if customer want flower store employees to deliver the flowers, then customer must to give all necessary information for successful delivery of the flowers, including, but not limited to address of delivery, person who receives delivery phone number, time and date for delivery, and the like;
f) flower store employee may offer to its customer's opportunity to send additional messages along with the flowers;
g) if customer do not want to send additional messages along with the flowers, then flower store employees send all necessary information needed for successful delivery to the delivery flower store, using flower stores managing company web site service providing system, where flower store web site service providing system and delivery flower store web site service providing system are members;
h) flower store may keep part of customer's money for its expenses, and other part of the money to sent to the flower stores managing company, where flower store managing company may also keep part of the money for its services, and rest of the money to send to delivery flower store for preparing the flower and delivery the same one;
i) flower stores managing company is adequately and functionally connected to the financial institutions devices that transfers money from one account to another, and its services are offered to all flower stores that are members of the flower stores managing company; financial institution may keep part of the money as a payment for its services;
j) delivery flower store receive the money and information about delivery, prepare the flower according the received information from flower store, and delivers the flower at the desired address;
k) if customer want to send additional messages along with the flower, then flower store employee ask the customer if he/she need help for creating the messages;
l) if customer do not needs help for creating messages, then customer use its own knowledge, devices, hardware and software, including, but not limited to digital photo cameras, digital audio devices, digital audio-video devices, and the like, for creating the messages, and place them on its own web page;
m) every flower store customers has its own web page located under flower stores managing company web site service providing system address:
n) additional messages that are prepared by the customer are posted to customer's web page and send to delivery customer's web page;
o) if customer needs a help for creating additional messages, then flower store employee may help the customer, or offer services from businesses and people that have a business contract with flower store;
p) businesses and people may charge a fee or will do it for free; customer pays that fee;
q) after creating the additional images and paying for them, businesses and people may post those messages to the receiver customer's web page, through adequate flower stores web site service providing system;
r) receiver receive information that messages are posted on receiver's web page; receiver may reach its web page using computer with internet access, hand held devices with internet access, mobile (cell) phone with internet access, and the like;
s) at approximately same time, receive receives flower too, so receiver may enjoy the flower along with the messages;
t) receiver sign proof of delivery and give it back to the delivery store employee, who sends the proof to the customer who order the flower, using the services of managing company;
u) all this method may be repeated.

10. A business method for improving the flower industry future comprising:
a) flower store has a business agreement with local stores for free of for fee paid by the businesses to the flower store for using flower store world wide network;
b) flower store customer may use products and services from those local businesses;
c) flower store has business agreements with other businesses through flower stores managing company, where products and services of those businesses are located on the flower stores managing company web site;
d) customer may use products and services from those businesses using web site service providing system that is adequately and functionally connected to the flower store web site service providing system;
e) flower store, flower store web site service providing system and flower stores web site service providing system offer to its customers opportunity to search, choose, order and pay for products and services offered by businesses that have business contract with them;
f) flower store located close to receiver's address of living may have business contracts with local businesses;
g) customer may reach the web site of the flower store located close to the receiver's address of living, using its own web site service providing system that is adequately and functionally connected to the flower store web site service providing system located close to the receiver's address of living, through flower stores managing company web site service providing system;
h) customer may reach the web site of the flower store located close to the receiver's address of living, using flower store web site service providing system that is adequately and functionally connected to the flower store web site service providing system located close to the receiver's address of living, through flower stores managing company web site service providing system;
i) customer may search, choose, order and pay for products and services that are offered to the flower store located close to the receiver's address of living web site by businesses that has business agreement with flower store located close to the receiver's address of living;
j) flower store located close to the receiver's address of living receive payment trough flower stores managing company web site service providing system, where the managing company keeps part of the money as a payment for it services, and rest of the money sends to the flower store located close to the receiver's address of living account trough financial institution payments devices;
k) after paying for products and services, flower store located close to the receiver's address of living deliver products and services to the receiving customer;
l) receiver also receives information where he/she can pick up products and services that are ordered from customer;
m) after picking up the products and services from businesses, receiver sign a document that receive the products and services, and with that document businesses employee proof that products and services are delivered;
n) flower store located close to the receiver's address of living pay to the businesses for those products and services from the money send by customer, less for managing company service fee, less for flower store located close to the receiver's address of living service fee, and less for all taxes that needs to be paid.
